(19) United States
(12) Patent Application Publication
(10) Pub. No.: US 2024/0201677 A1
(43) Pub. Date: Jun. 20, 2024

(54) HUMAN SKILL LEARNING BY INVERSE REINFORCEMENT LEARNING

(71) Applicant: FANUC CORPORATION, Yamanashi (JP)

(72) Inventors: Kaimeng Wang, Fremont, CA (US); Yu Zhao, Santa Clara, CA (US)

(21) Appl. No.: 18/068,760

(22) Filed: Dec. 20, 2022

(51) Int. Cl. G05B 19/423; B25J 9/16; G06N 3/092

(52) U.S. Cl. CPC G05B 19/423; B25J 9/1697; G06N 3/092

(57) ABSTRACT

A method for teaching a robot to perform an operation including human demonstration using inverse reinforcement learning and a reinforcement learning reward function. A demonstrator performs an operation with contact force and workpiece motion data recorded. The demonstration data is used to train an encoder neural network which captures the human skill, defining a Gaussian distribution of probabilities for a set of states and actions. Encoder and decoder neural networks are then used in live robotic operations, where the decoder is used by a robot controller to compute actions based on force and motion state data from the robot. After each operation, the reward function is computed, with a Kullback-Leibler divergence term which rewards a small difference between human demonstration and robot operation probability curves, and a completion term which rewards a successful operation by the robot. The decoder is trained using reinforcement learning to maximize the reward function.

### BACKGROUND

### Field

The present disclosure relates to the field of industrial robot motion programming and, more particularly, to a method for programming a robot to perform a workpiece placement operation, where skills are captured using inverse reinforcement learning during a human demonstration phase, and a reward function which compares robot skills to human skills is used in a reinforcement learning phase to define a policy which controls optimal actions by the robot.

### Discussion of the Related Art

The use of industrial robots to repeatedly perform a wide range of manufacturing, assembly and material movement operations is well known. However, teaching a robot to perform even a fairly simple operation—such as picking up a workpiece in a random position and orientation from a bin and moving the workpiece to a container or a conveyor—has been unintuitive, time-consuming and/or costly using conventional methods. Teaching component assembly operations is even more challenging.

Robots have traditionally been taught to perform pick and place operations of the type described above by a human operator using a teach pendant. The teach pendant is used by the operator to instruct the robot to make incremental moves—such as “jog in the X-direction” or “rotate gripper about local Z-axis”—until the robot and it's gripper are in the correct position and orientation to grasp the workpiece. Then the robot configuration and the workpiece pose are recorded by the robot controller to be used for the “pick” operation. Similar teach pendant commands are then used to define the “move” and “place” operations. However, the use of a teach pendant for programming a robot is often found to be difficult, error-prone and time-consuming, especially to non-expert operators. Motion capture systems have also been used for robot teaching, but these systems are costly and require extensive set-up time in order to obtain accurate results.

Robot teaching by human demonstration is also known, but may lack the positional accuracy needed for precise placement of the workpiece, as is needed for applications such as component installation and assembly. This is particularly true when the component installation is performed using a robot with a force controller, in which case the force signals captured during the human demonstration—and their relationship to the required positional adjustments—may be entirely different than those encountered by the robot during installation.

In light of the circumstances described above, there is a need for an improved robot teaching technique which captures the essence of the skills taught by human demonstration and uses the skills to perform the robotic installation operation with the required dexterity.

### SUMMARY

The present disclosure describes a method for teaching and controlling a robot to perform an operation based on human demonstration using inverse reinforcement learning, and a reinforcement learning reward function including a Kullback-Leibler (KL) divergence calculation. A human demonstrator performs an operation such as a component installation, with workpiece force and motion data being recorded. The force and motion data from the human demonstration is used to train encoder and decoder neural networks which capture the human skill, where the encoder defines a Gaussian distribution of probabilities associated with a set of state and action data, and the decoder determines actions associated with a set of state data and a corresponding best probability. Encoder and decoder neural networks are then used in live robotic operations, where the decoder is used by a robot controller to compute actions based on force and motion state data from the robot. After each operation is completed, the reward function is computed, with a KL divergence term which rewards a small difference between human demonstration and robot operation probability curves from the encoder neural network, and a completion term which rewards a successful component installation by the robot. The decoder neural network is trained using reinforcement learning to maximize the reward function.

Additional features of the presently disclosed devices and methods will become apparent from the following description and appended claims, taken in conjunction with the accompanying drawings.

### BRIEF DESCRIPTION OF THE DRAWINGS

FIG. 1 is a block diagram illustration depicting the high level concepts involved in a human demonstration and robotic operation system, including both inverse reinforcement learning and forward reinforcement learning techniques, according to an embodiment of the present disclosure;

FIG. 2 is a block diagram illustration depicting how a Kullback-Leibler (KL) divergence calculation is used to construct a reward function which yields a greater reward when a difference between human demonstration and robotic operation probability curves is smaller, according to an embodiment of the present disclosure;

FIG. 3 is a block diagram illustration depicting how a decoder neural network is used to control robot motion, and the reward function, with a KL divergence term and a success term, is used for ongoing system training, according to an embodiment of the present disclosure;

FIG. 4 is an illustration of a system for human demonstration of a component installation operation, where camera images of the demonstrator's hand are used to determine workpiece motion, and force data is sensed from beneath a fixed workpiece, according to an embodiment of the present disclosure;

FIG. 5 is a block diagram illustration depicting how encoder and decoder neural networks are initially trained based on state and action data from the human demonstration, according to an embodiment of the present disclosure;

FIG. 6 is a schematic diagram illustrating a system with an encoder neural network trained using human demonstration data, and encoder and decoder neural networks used during robot operations with ongoing training of the decoder to maximize the reward function, according to an embodiment of the present disclosure; and

FIG. 7 is a flowchart diagram of a method for teaching and controlling a robot to perform an operation based on human demonstration using inverse reinforcement learning, and ongoing reinforcement learning with a reward function including a KL divergence calculation, according to an embodiment of the present disclosure.

### DETAILED DESCRIPTION OF THE EMBODIMENTS

The following discussion of the embodiments of the disclosure directed to a method for teaching and controlling a robot to perform an operation based on human demonstration using inverse reinforcement learning is merely exemplary in nature, and is in no way intended to limit the disclosed devices and techniques or their applications or uses.

It is well known to use industrial robots for a variety of manufacturing, assembly and material movement operations. One known type of robotic operation is a “pick, move and place”, where a robot picks up a part or workpiece from a first location, moves the part and places it at a second location. A more specialized type of robotic operation is assembly, where robot picks up one component and installs or assembles it into a second (usually larger, and fixed in location) component.

It has long been a goal to develop simple, intuitive techniques for training robots to perform part movement and assembly operations. In particular, various methods of teaching by human demonstration have been developed. These include the human using a teach pendant to define incremental robotic movements, and motion capture systems where movements of the human demonstrator are captured at a specialized workspace using sophisticated equipment. None of these techniques have proven to be both cost-effective and accurate.

Another technique for robot teaching by human demonstration was disclosed in U.S. patent application Ser. No. 16/843,185, titled ROBOT TEACHING BY HUMAN DEMONSTRATION, filed Apr. 8, 2020 and commonly assigned with the present application, and herein incorporated by reference in its entirety. The aforementioned application is hereinafter referred to as “the '185 application”. In the '185 application, camera images of the human hand(s) moving the workpiece from a start location to a destination location are analyzed, and translated into robot gripper movement commands.

The techniques of the '185 application work well when fine precision is not needed in placement of the workpiece. However, in precision placement applications such as robotic installation of a component into an assembly, uncertainty in the grasp pose of the workpiece in the hand can lead to minor inaccuracies. In addition, installation operations often require the use of a force-feedback controller on the robot, which necessitates a different type of motion control algorithm.

When a force controller is used for robot control in contact-based applications such as component installation, direct usage by the robot controller of measured forces and motions from human demonstration is problematic. This is because a very small difference in workpiece position can result in a very large difference in the resulting contact force—such as when a peg makes contact with one edge of the rim of a hole versus an opposite edge. In addition, a robot force controller inherently responds differently than a human demonstrator, including differences in force and visual sensation and differences in frequency response. Thus, using human demonstration data directly in a force controller typically fails to produce the desired results.

In view of the circumstances described above, a technique is needed for improving the precision of robotically-controlled workpiece placement during an installation operation. The present disclosure accomplishes this by using a combination of inverse reinforcement learning and forward reinforcement learning, where inverse reinforcement learning is used to capture human skills during a demonstration phase, and forward reinforcement learning is used for ongoing training of a robot control system which mimics the skills rather than directly computing an action from the human demonstration data. These techniques are discussed in detail below.

Reinforcement learning and inverse reinforcement learning are known techniques in the field of machine learning. Reinforcement learning is a machine learning training method based on rewarding desired behaviors and/or punishing undesired ones. In general, a reinforcement learning agent is able to perceive and interpret its environment, take actions and learn through trial and error. Inverse reinforcement learning is a machine-learning framework that can solve the inverse problem of RL. Basically, inverse reinforcement learning is about learning from humans. Inverse reinforcement learning is used to learn an agent's goals or objectives, and establish rewards, by observing the human agent's behavior. The present disclosure combines inverse reinforcement learning with reinforcement learning in a new way—where inverse reinforcement learning is used to learn human skill from demonstration, and a reward function based upon adherence to the learned human skill is used to train a robot controller using reinforcement learning.

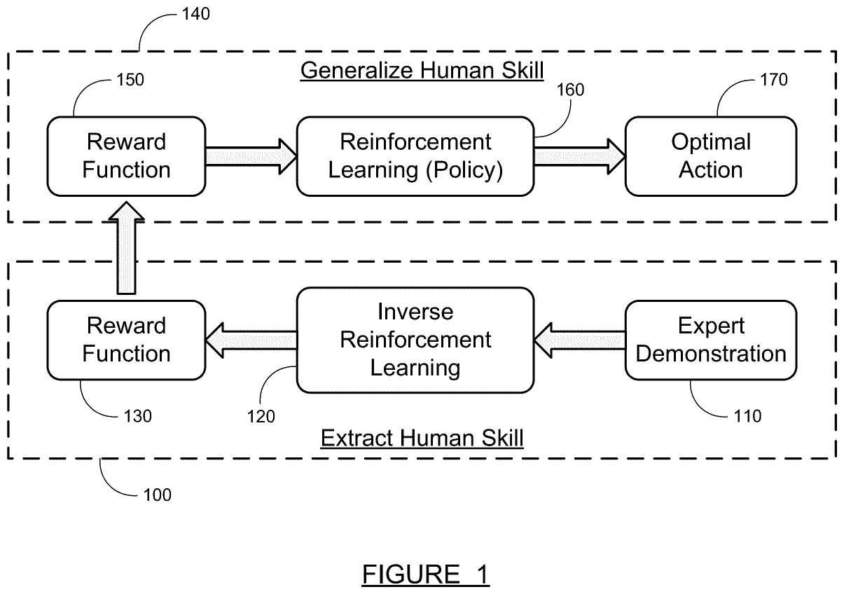

FIG. 1 is a block diagram illustration depicting the high level concepts involved in a human demonstration and robotic operation system, including both inverse reinforcement learning and forward reinforcement learning techniques, according to an embodiment of the present disclosure. In box 100, an inverse reinforcement learning technique is used to extract human skills during a demonstration phase, where a human demonstrator performs a part installation task. In block 110, the human demonstrates the task, such as inserting a peg into a hole, or installing an electronic component on a circuit board in a housing. At block 120, inverse reinforcement learning is used to train encoder and decoder neural networks to capture the human skill exhibited during demonstration. At block 130, a reward function is constructed which rewards adherence to the demonstrated human skills.

In box 140, the demonstrated human skills are generalized in a reinforcement learning technique which trains a robot controller to mimic the human skills. In block 150, the reward function from inverse reinforcement learning based on the human demonstration is used in block 160 for reinforcement learning. The reinforcement learning performs ongoing training of the robot controller, rewarding robot behavior which replicates the human skills and which results in successful component installation, resulting in optimal robot action or performance at block 170. Details of the concepts illustrated in FIG. 1 are discussed below.

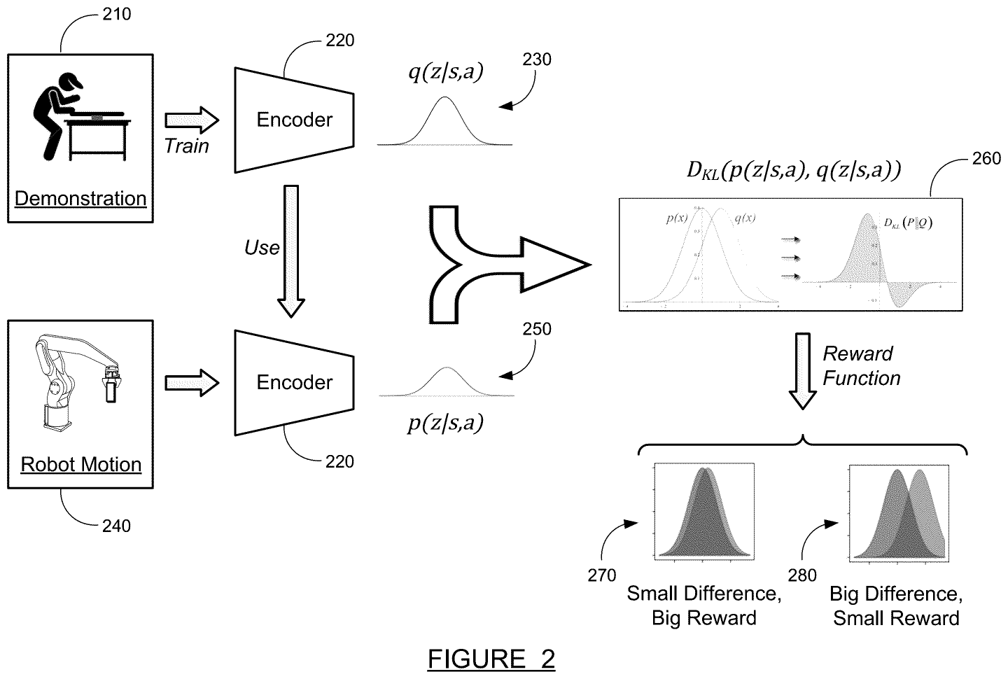

FIG. 2 is a block diagram illustration depicting how a Kullback-Leibler (KL) divergence calculation is used to construct a reward function which yields a greater reward when a difference between human demonstration and robotic operation probability curves is smaller, according to an embodiment of the present disclosure. In box 210, a human demonstration of a task is performed. For the purposes of the discussion of the presently disclosed techniques, the task is installing one component into another. For example, a peg in hole insertion, where the peg is held and manipulated by the human demonstrator and the hole is formed in a component which is held in a fixed position. The human demonstration in the box 210 corresponds to the block 110 of FIG. 1.

Data from the human demonstration box 210 is used to train an encoder neural network 220. This training uses an inverse reinforcement methodology, and as discussed later in detail. The encoder neural network 220 provides a function q which defines a probability z corresponding with a state s and an action a. The function q is a Gaussian distribution of the probabilities z, as shown at 230. Later, in robotic operations shown in box 240, robot motions and states are captured and used in the encoder 220 to produce a function p, which also relates probabilities z to states s and actions a, as shown at 250. The probability z is a mapping of the relationship between states s and actions a to a Gaussian distribution representation via the encoder neural network 220.

A Kullback-Leibler (KL) divergence calculation is used to produce a numeric value which represents the amount of difference between the Gaussian distribution from the function p and the distribution from the function q. The probability curves p and q are shown at the left in box 260. The KL divergence calculation first computes the difference between the distribution curves, as shown at the right in the box 260, and then integrates the area under the difference curve. The KL divergence calculation can be used as part of a reward function, where a small difference between the p and q distributions results in a big reward (shown at 270), and a big difference between the p and q distributions results in a small reward (shown at 280).

The training of the encoder neural network 220 using an inverse reinforcement learning technique is discussed in detail below, as is the reward function and its usage in a reinforcement learning training of a robot controller.

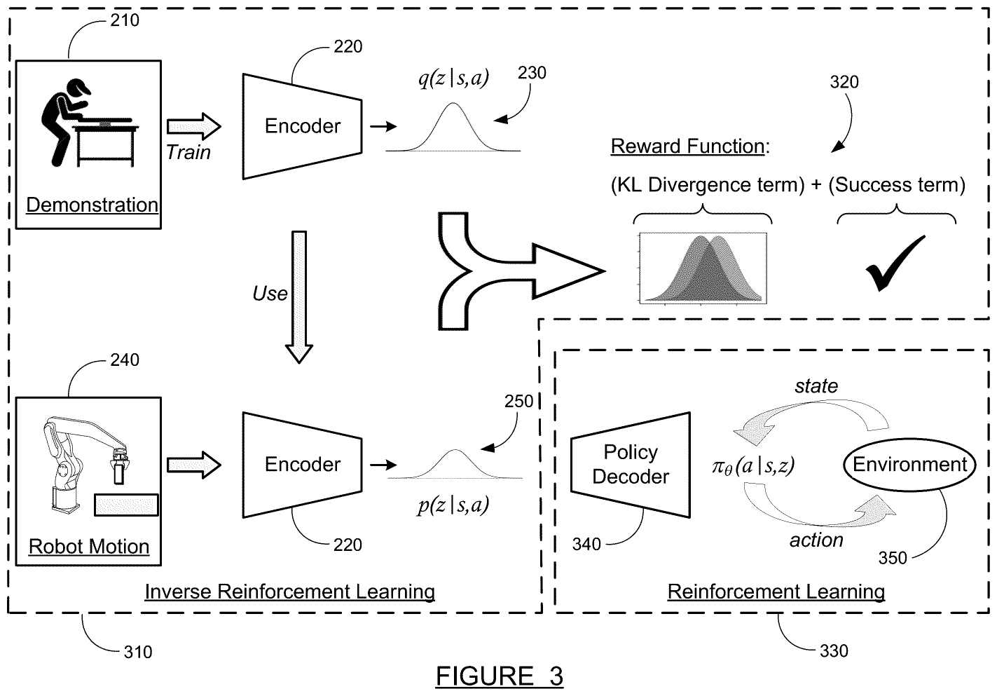

FIG. 3 is a block diagram illustration depicting how a decoder neural network is used to control robot motion, and the reward function, with a KL divergence term and a success term, is used for ongoing system training, according to an embodiment of the present disclosure. Box 310 includes the inverse reinforcement learning phase, which is used to train the encoder neural network 220 as discussed above with respect to FIG. 2. The encoder neural network 220 produces the function q defining probabilities z corresponding to states s and actions a from human demonstration. Once trained, the encoder neural network 220 is also used to produce the function p defining probabilities z corresponding to states s and actions a from robot motion.

In a preferred embodiment of a reward function, shown at 320, the reward function includes a KL divergence term (greater reward for smaller difference between the p and q distributions), and a success term. The success term increases the reward when the robotic installation operation is successful. Thus, the reward function encourages robotic behavior which matches the skills of an expert human demonstrator (via the KL divergence term), and also encourages robotic behavior which results in a successful installation operation (via the success term).

A preferred embodiment of the reward function is defined below in Equation (1):

$$J ( θ ) = {𝔼}_{{π}_{θ}} [ - {\sum }_{t = 0}^{T - 1} α {D}_{KL} ( p ( z \vert s , a ) , q ( z \vert s , a ) ) + {r}_{done} ] \qquad ( 1 )$$

Where J is the reward value for a set of parameters θ of a policy decoder distribution function π, [symbol] is the expectation of the probability, α is a constant, D_{KL} is the KL divergence value calculated for the distributions p and q, and r_{done} is the success reward term. In Equation (1), the summation is taken over all of the steps of the robotic operation, so the KL divergence term is computed at each step, and the final reward for the operation is calculated using the summation and the success term if applicable. The constant a and the success reward term r_{done} can be selected to achieve the desired system performance in the reinforcement learning phase.

The overall procedure works as follows. In the inverse reinforcement learning box 310, human demonstration at the box 210 is used to train the encoder neural network 220 as described earlier and discussed in detail below. In a reinforcement learning box 330, a policy decoder neural network 340 defines a function π which determines an action a corresponding with a state vector s and a probability z. The action a is used by the robot controller to control the robot which is manipulating the workpiece (e.g., the peg being inserted into a hole). The robot and the fixed and moving workpieces are represented by environment 350 in FIG. 3. The state vector s, which includes forces and torques along with translational and rotational velocities, is fed back to the policy decoder 340 to compute the next action a. As the robot manipulates the workpiece (shown in the box 240), the robot motions are fed through the encoder 220 to produce the distribution p. The distribution q is known from the earlier human demonstration. After each robotic installation operation is completed (successfully or otherwise), the reward function shown at 320 is computed using Equation (1), and the reward function is used for ongoing training of the policy decoder 340.

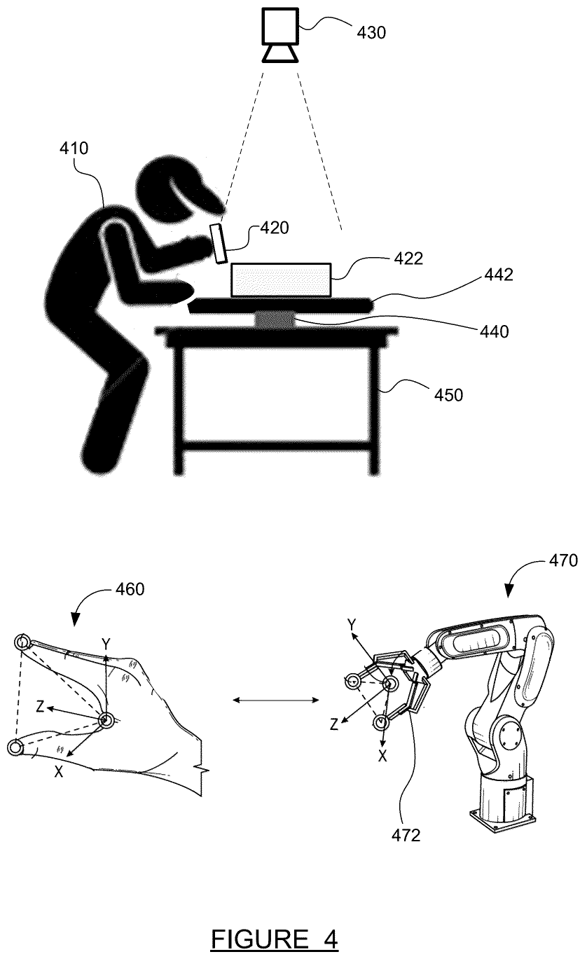

FIG. 4 is an illustration of a system for human demonstration of a component installation operation, where camera images of the demonstrator's hand are used to determine workpiece motion, and force data is sensed from beneath a fixed workpiece, according to an embodiment of the present disclosure. In FIGS. 2 and 3 discussed above, the human demonstration box 210 provided data describing the expert human performing the operation such as peg in hole insertion, and the data was used to train the encoder neural network 220. FIG. 4 illustrates how the data is captured in a preferred embodiment.

Known methods for data capture during human demonstration typically use one of two techniques. A first technique involves fitting the workpiece being manipulated by the demonstrator with a force sensor to measure contact forces and torques. In this first technique, the motion of the workpiece is determined using a motion capture system. Drawbacks of this technique include the fact that the force sensor physically changes user's gripping location and/or the manipulation feel of the workpiece, and the fact that the workpiece may be partially occluded by the demonstrator's hand.

The second technique is to have the human demonstrate the operation using a workpiece which is also being grasped by a collaborative robot. This technique inherently affects the manipulative feel of the workpiece to the human demonstrator, which causes the demonstrated operation to be different than it would have been with a freely movable workpiece.

The presently disclosed method for inverse reinforcement learning uses a technique for data collection during human demonstration which overcomes the disadvantages of the known techniques discussed above. This includes analyzing images of the demonstrator's hand to compute corresponding workpiece and robot gripper poses, and measuring forces from beneath the stationary workpiece rather than from above the mobile workpiece.

A human demonstrator 410 manipulates a mobile workpiece 420 (e.g., a peg) which is being installed into a stationary workpiece 422 (e.g., a component including a hole into which the peg is being inserted). A 3D camera or other type of 3D sensor 430 captures images of the demonstration scene in the workspace. A force sensor 440 is situation beneath a platform 442 (i.e., a jig plate or the like), and the force sensor 440 is preferably located on top of a table or stand 450. Using the experimental setup shown in FIG. 4, the demonstrator 410 can freely manipulate the mobile workpiece 410 during the installation operation, and the camera 430 is able to capture images of the demonstrator's hand without risk of workpiece occlusion. The camera images (defining hand motion and therefore corresponding gripper motion, and workpiece motion), along with the force and torque data from the sensor 440 beneath the platform 442, are provided to the computer which is training the encoder neural network 220.

The lower portion of FIG. 4 depicts a hand 460 of the human demonstrator, with a coordinate frame overlaid on the hand 460. A robot 470 having a gripper 472 are also shown. The '185 application, discussed earlier and incorporated by reference, discloses techniques for analyzing camera images of the human hand moving a workpiece, and translating the hand movements into robot gripper movements. These technique can be used with the experiment platform depicted in FIG. 4 to provide the human demonstration data needed to train the encoder neural network 220 according to the present disclosure.

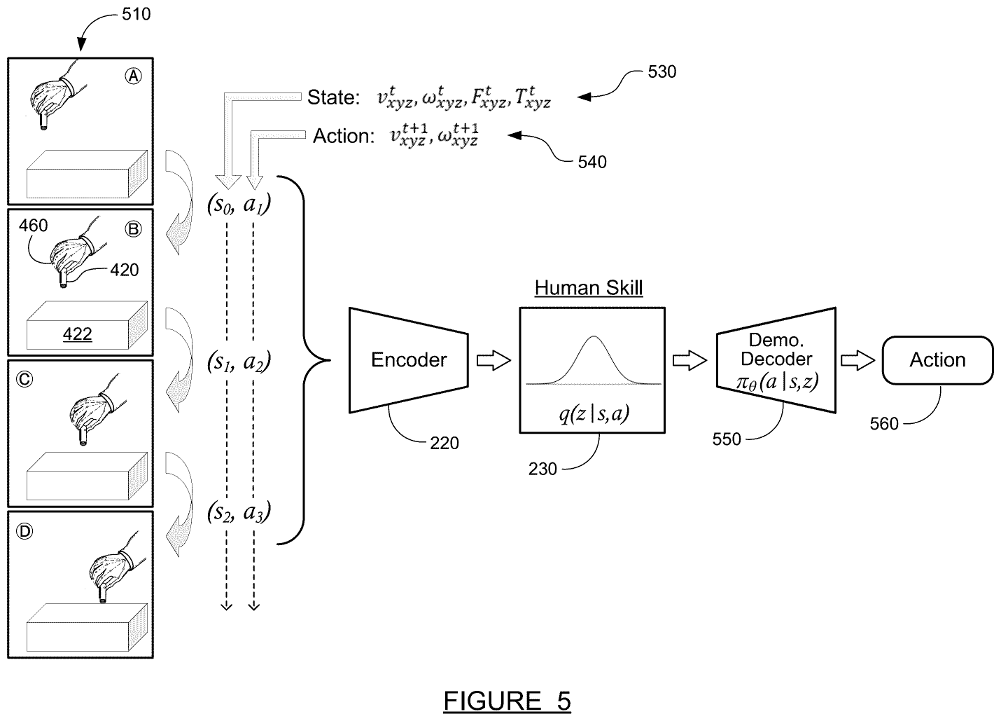

FIG. 5 is a block diagram illustration depicting how encoder and decoder neural networks are initially trained based on state and action data from the human demonstration, using inverse reinforcement learning techniques, according to an embodiment of the present disclosure. A sequence of steps from human demonstration are depicted in boxes 510 \textcircled{A}, \textcircled{B}, \textcircled{C}, and \textcircled{D}. The steps of the human demonstration depict the demonstrator's hand 460 manipulating the mobile workpiece 420 for installation into the stationary workpiece 422.

As discussed earlier, the encoder neural network 220 defines a probability z corresponding with a state s and an action a. In the case of the human demonstration, this is the distribution q. In FIG. 5, the state vector s is shown at 530, and the action vector a is shown at 540. The state vector s includes, for a time step t, three orthogonal translational and three rotational velocities (νₓ, ν_{y}, ν_{z}, ωₓ, ω_{y}, ω_{z}), along with three orthogonal forces (Fₓ, F_{y}, F_{z}) and three torques (Tₓ, T_{y}, T_{z}). The action vector a includes the translational and rotational velocities (ν and ω) for a time step t+1.

The demonstration steps depicted in the boxes 510 \textcircled{A} and \textcircled{B} provide a corresponding set of state and action vectors (S₀, a₁) as follows. The state s₀ is defined by the workpiece velocities and the contact forces/torques from the step contained in the box 510 \textcircled{A}. The action a₁ is defined by the workpiece velocities from the step contained in the box 510 \textcircled{B}. This arrangement mimics the operation of a robot controller, where a state vector is used in a feedback control calculation to determine a next action. All of the velocity, force and torque data for the states 530 and the actions 540 are provided by the experiment platform setup depicted in FIG. 4 and described above.

The data from the sequence of steps of human demonstration provides a sequence of corresponding state and action vectors—(S₀, a₁), (s₁, a₂), (s₂, a₃), and so forth—which is used to train the encoder neural network 220. As discussed earlier, the encoder neural network 220 produces a distribution q of probabilities z associated with a state s and an action a. The distribution q captures the human skill from the demonstration of the operation.

A demonstration decoder 550 is then used to determine an action a corresponding with a state s and a probability z. Training of the encoder neural network 220 continues from human demonstration data until the actions a (shown at box 560) produced by the demonstration decoder 550 converge to the actions a (shown at 540) provided as input to the encoder 220. Training of the encoder neural network 220 may be accomplished using a known loss function approach, or another technique as determined most suitable.

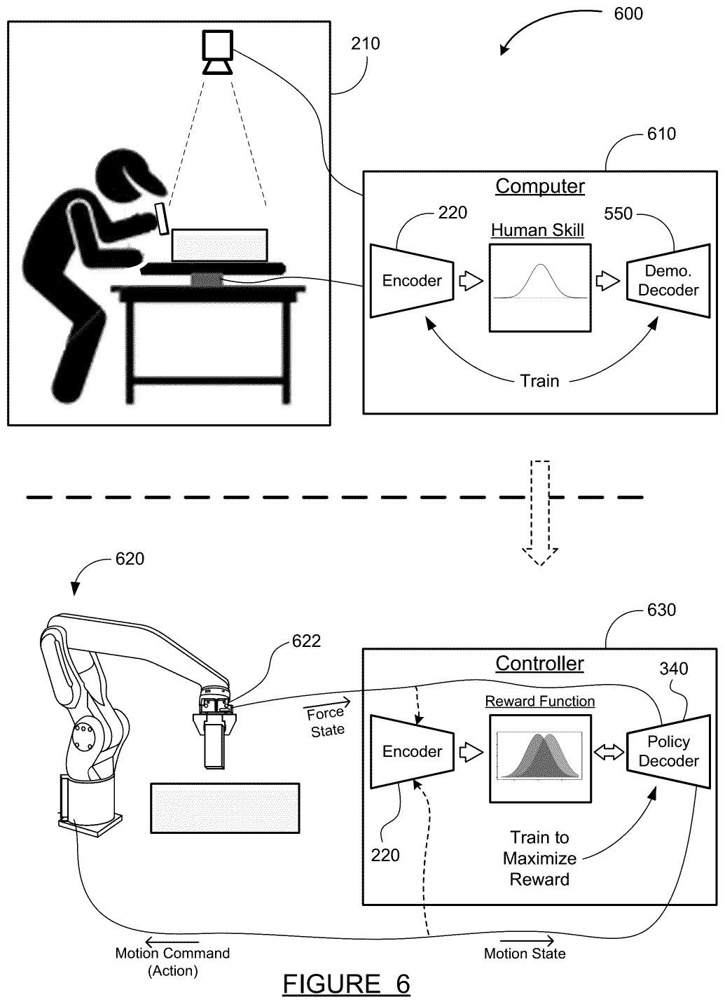

FIG. 6 is a schematic diagram illustrating a system 600 with an encoder neural network trained using human demonstration data, and encoder and decoder neural networks used during robot operations with ongoing training of the decoder to maximize the reward function, according to an embodiment of the present disclosure. The main concepts of using inverse reinforcement learning to train an encoder to capture human skills from demonstration, and using reinforcement learning to train a decoder to optimize a reward function in robot operations, have been discussed at length above. FIG. 6 is provided simply to illustrate an exemplary computing environment implementation of the above-mentioned concepts.

A computer 610 is used to capture data from the human demonstration depicted in the box 210. The computer 610 receives images from the camera 430 and the force sensor 440 (FIG. 4), which data define the states s and the actions a used to train the encoder neural network 220 as described with respect to FIG. 5. The demonstration decoder 550 is also shown running on the computer 610. The computer 610 may be a device which is separate from the robot controller used later for controlling the robot. For example, the computer 610 may be a standalone computer located in an experimental workcell where the human demonstration is performed as illustrated in FIG. 4. Once the encoder neural network 220 is trained with the human demonstration data, the encoder 220 does not change during its usage in subsequent robotic operations.

A robot 620 is in communication with a controller 630, in a manner known to those familiar with industrial robots. The robot 620 is configured with a force sensor 622 which measures contact forces and torques during robotic installation of the mobile workpiece 420 into the stationary workpiece 422. The force and torque data is provided as state data feedback to the controller 630. The robot has joint encoders which provide motion state data (joint rotational positions and velocities) as feedback to the controller 630. The controller 630 determines a next action (motion command) based on the most recent state data and the probability function from the policy decoder 340, as illustrated on FIG. 3 and discussed above.

The state and action data are also provided to the encoder neural network 220, as depicted by the dashed lines. At the completion of each robotic installation operation, the encoder 220 uses the robot state and action data (the distribution p) and the known distribution q from human demonstration to compute the reward function using the KL divergence calculation discussed earlier. The reward function also incorporates the success reward term if application, as defined above in Equation (1). Ongoing training of the policy decoder 340 is performed using reinforcement learning, causing adaptation of the policy decoder neural network 340 to maximize the reward.

The ongoing training of the policy decoder neural network 340 may be performed on a computer other than the robot controller 630—such as the computer 610 discussed above, or yet another computer. The policy decoder 340 is shown as residing on the controller 630 so that the controller 630 can use force and motion state feedback from the robot 620 to determine a next action (motion command) and provide the motion command to the robot 620. If the reinforcement learning training of the policy decoder neural network 340 takes place on a different computer, then the policy decoder 340 would be periodically copied to the controller 630 for control of robot operations.

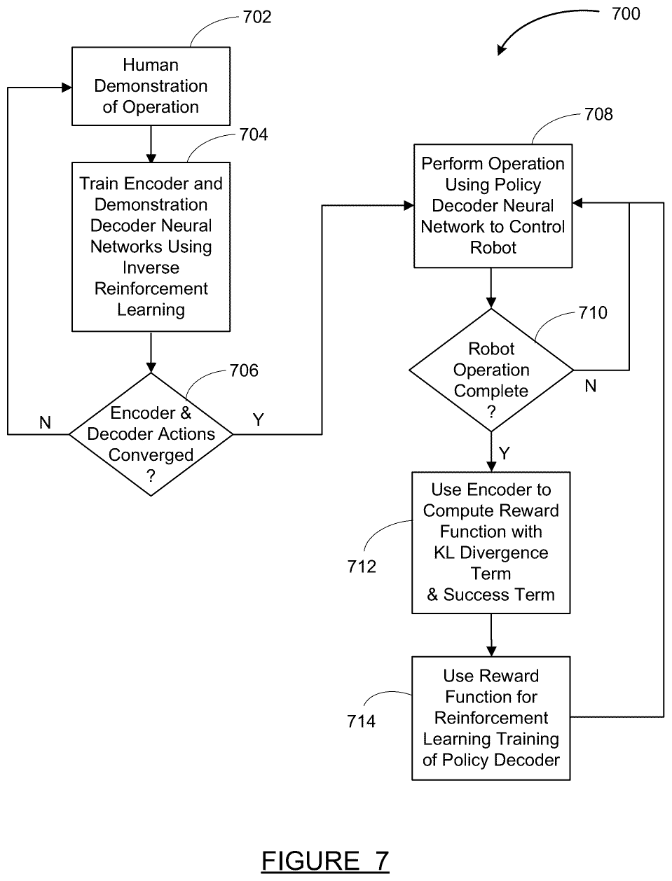

FIG. 7 is a flowchart diagram 700 of a method for teaching and controlling a robot to perform an operation based on human demonstration using inverse reinforcement learning, and ongoing reinforcement learning with a reward function including a KL divergence calculation, according to an embodiment of the present disclosure. At box 702, a human expert performs a demonstration of an operation—such as a peg in hole insertion—as depicted in the box 210 of FIGS. 2 and 3. The human demonstration at the box 702 is performed in a workcell as shown in FIG. 4, with a 3D sensor or camera recording hand position data as the operator manipulates a mobile workpiece, and a force sensor located underneath a stationary workpiece.

At box 704, a decoder neural network and a demonstration decoder neural network are trained using data from the human demonstration. The data from the demonstration includes states (velocities and forces in six degrees of freedom), and actions (velocities in six degrees of freedom). The decoder neural network is trained using inverse reinforcement learning techniques to capture the skill of the human demonstrator. At decision diamond 706, it is determined whether the actions output from the decoder neural network have converged with the actions input to the encoder. If not, training continues, with the human expert performing another demonstration. When the inverse reinforcement learning training is complete (actions have converged at the decision diamond 706), the process moves on to robotic execution.

At box 708, a robot performs the same operation as was demonstrated by the human expert. The robot controller is configured with a policy decoder neural network which computes actions (velocities) associated with a state vector (forces and velocities, provided as feedback from the robot) and a probability distribution. At decision diamond 710, it is determined whether the robotic operation is complete. If not, the operation continues at the box 708. State and action data are captured at every step of robot operation.

At box 712, after the robotic operation is complete, the encoder neural network (trained at steps 702-706) is used to provide a probability distribution curve from the robot operations, and the probability distribution curve from robot operations is compared to a probability distribution curve from human demonstration in a KL divergence calculation. The KL divergence calculation is performed for each step of the robot operation, and a reward function is computed from a summation of the KL divergence calculations and a success term. At box 714, the reward value computed from the reward function is used for reinforcement learning training of the policy decoder neural network. The process returns to the box 708 where the robot performs another operation. In steps 708-714, the policy decoder used by the robot controller learns how to select actions (robot motion commands) which mimic the skill of the human demonstrator and which will lead to a successful operation.

Throughout the preceding discussion, various computers and controllers are described and implied. It is to be understood that the software applications and modules of these computer and controllers are executed on one or more computing devices having a processor and a memory module. In particular, this includes the processors in the computer 610 and the robot controller 630 discussed above, along with the optional separate computer discussed relative to FIG. 6. Specifically, the processors in the controller/computer are configured to perform the robot teaching via human demonstration, including inverse reinforcement learning in a human demonstration phase and reinforcement learning in a robotic execution phase, in the manner discussed above.

As outlined above, the disclosed techniques for robot teaching by human demonstration using inverse reinforcement learning, with subsequent robot controller training using reinforcement learning, provide several advantages over existing robot teaching methods. The disclosed techniques provide the intuitiveness advantages of human demonstration, while being robust enough to apply the human demonstrated skills in a force controller environment which adapts to reward desired behavior.

While a number of exemplary aspects and embodiments of robot teaching by human demonstration using inverse reinforcement learning have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for teaching a robot to perform an operation by human demonstration, said method comprising:
performing the demonstration of the operation by a human hand, including manipulating a moving workpiece relative to a fixed workpiece;
recording force and motion data from the demonstration, by a computer, to create demonstration data, including demonstration state data and demonstration action data;
using the demonstration data to train a first neural network to output a first distribution of probabilities associated with the demonstration state data and the demonstration action data;
performing the operation by a robot, including using a robot controller configured with a policy neural network which determines robot action data to provide as a robot motion command based on robot state data provided as feedback from the robot;
computing a value of a reward function following completion of the operation by the robot, including using the first neural network to output a second distribution of probabilities associated with the robot state data and the robot action data, and using the first and second distributions of probabilities in a Kullback-Leibler (KL) divergence calculation in the reward function; and
using the value of the reward function in ongoing reinforcement learning training of the policy neural network.

2. The method according to claim 1 wherein the operation is an installation of the moving workpiece into an aperture of the fixed workpiece including contact between the moving workpiece and the fixed workpiece during the installation.

3. The method according to claim 2 wherein the demonstration state data used in the training of the first neural network and the robot state data used by the policy neural network include contact forces and torques between the moving workpiece and the fixed workpiece.

4. The method according to claim 3 wherein the contact forces and torques between the moving workpiece and the fixed workpiece in the demonstration state data are measured by a force sensor positioned between the fixed workpiece and a stationary fixture.

5. The method according to claim 1 wherein the demonstration state data and the demonstration action data include translational and rotational velocities of the moving workpiece which are determined by analyzing camera images of the human hand during the demonstration.

6. The method according to claim 1 wherein the first neural network has an encoder neural network structure, and using the demonstration data to train the first neural network continues until action data provided as output from a demonstration decoder neural network converges to the demonstration action data provided as input to the encoder neural network.

7. The method according to claim 1 wherein the reward function includes a KL divergence term which is greater when a difference between the first and second distributions of probabilities is smaller, and a success term which is added when the operation by the robot is successful.

8. The method according to claim 7 wherein the KL divergence term in the reward function includes a summation of the KL divergence calculations for each step of the operation by the robot.

9. The method according to claim 8 wherein the KL divergence calculations include computing a difference curve as a difference between the first and second distributions of probabilities and then integrating an area under the difference curve.

10. The method according to claim 1 wherein the reinforcement learning training trains the policy neural network with an objective of maximizing the value of the reward.

11. A method for teaching a robot to perform an operation by human demonstration, said method comprising:
performing the demonstration of the operation by a human hand, including installing a moving workpiece into an aperture in a fixed workpiece;
recording force and motion data from the demonstration, by a computer, to create demonstration data, including demonstration state data and demonstration action data, where the demonstration data includes translational and rotational velocities of the moving workpiece and contact forces and torques between the moving workpiece and the fixed workpiece;
using the demonstration data to train a first neural network to output a first distribution of probabilities associated with the demonstration state data and the demonstration action data;
performing the operation by a robot, including using a robot controller configured with a policy neural network which determines robot action data to provide as a robot motion command based on robot state data provided as feedback from the robot;
computing a value of a reward function following completion of the operation by the robot, including using the first neural network to output a second distribution of probabilities associated with the robot state data and the robot action data, and using the first and second distributions of probabilities in a Kullback-Leibler (KL) divergence calculation in the reward function, where the reward function includes a KL divergence term and a success term; and
using the value of the reward function in ongoing reinforcement learning training of the policy neural network to maximize the value of the reward function.

12. A system for teaching a robot to perform an operation by human demonstration, said system comprising:
a demonstration workcell including a three-dimensional (3D) camera and a force sensor providing data to a computer, where a human uses a hand to perform the demonstration of the operation by manipulating a moving workpiece relative to a fixed workpiece; and
a robot workcell including a robot in communication with a controller,
where the computer is configured to record force and motion data from the demonstration to create demonstration data, including demonstration state data and demonstration action data, and use the demonstration data to train a first neural network to output a first distribution of probabilities associated with the demonstration state data and the demonstration action data,
and where the controller is configured with a policy neural network which determines robot action data to provide as a robot motion command based on robot state data provided as feedback from the robot,
and the computer or the controller is configured to compute a value of a reward function following completion of the operation by the robot, including using the first neural network to output a second distribution of probabilities associated with the robot state data and the robot action data, use the first and second distributions of probabilities in a Kullback-Leibler (KL) divergence calculation in the reward function, and use the value of the reward function in ongoing reinforcement learning training of the policy neural network.

13. The system according to claim 12 wherein the demonstration state data used in the training of the first neural network and the robot state data used by the policy neural network include contact forces and torques between the moving workpiece and the fixed workpiece.

14. The system according to claim 12 wherein the force sensor is positioned between the fixed workpiece and a stationary fixture.

15. The system according to claim 12 wherein the demonstration state data and the demonstration action data include translational and rotational velocities of the moving workpiece which are determined by analyzing images of the hand captured by the camera during the demonstration.

16. The system according to claim 12 wherein the first neural network has an encoder neural network structure, and training the first neural network continues until action data provided as output from a demonstration decoder neural network converges to the demonstration action data provided as input to the encoder neural network.

17. The system according to claim 12 wherein the reward function includes a KL divergence term which is greater when a difference between the first and second distributions of probabilities is smaller, and a success term which is added when the operation by the robot is successful.

18. The system according to claim 17 wherein the KL divergence term in the reward function includes a summation of the KL divergence calculations for each step of the operation by the robot.

19. The system according to claim 18 wherein the KL divergence calculations include computing a difference curve as a difference between the first and second distributions of probabilities and then integrating an area under the difference curve.

20. The system according to claim 12 wherein the reinforcement learning training trains the policy neural network with an objective of maximizing the value of the reward.
